(19) United States
(12) Patent Application Publication
(10) Pub. No.: US 2004/0263629 A1
(43) Pub. Date: Dec. 30, 2004

(54) Image pickup apparatus and information processing method in the image pickup apparatus

(75) Inventors: Yasuhito Ambiru, Tokorazawa-shi (JP); Hiroshi Yoshimura, Saitama-shi (JP); Isao Ooshima, Kawasaki-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/812,985

(22) Filed: Mar. 31, 2004

(30) Foreign Application Priority Data
Jun. 30, 2003 (JP) 2003-188491

(51) Int. Cl. H04N 5/335

(52) U.S. Cl. 348/207.1

(57) ABSTRACT

An image pickup apparatus has an image pickup section which photographs an image and outputs its image information, a determining section which determines whether or not the image information should undergo a pixel addition processing according to a result of beam measurement, a pixel adding section which, when it is determined that the pixel addition processing should be executed, executes the pixel addition processing upon the image information, and a transmitting section for transmitting the image information which pixels are added to an external unit, wherein, when exposure becomes short, the pixel addition processing is automatically executed even unless user gives any instruction about the pixel addition processing under his determination for each time.

### CROSS-REFERENCE TO RELATED APPLICATIONS

This application is based upon and claims the benefit of priority from prior Japanese Patent Application No. 2003-188491, filed Jun. 30, 2003, the entire contents of which are incorporated herein by reference.

### BACKGROUND OF THE INVENTION

1. Field of the Invention

The present invention relates to an image pickup apparatus such as a network camera and more particularly to an image pickup apparatus in which information of photographed images is stored in storage sections of other image pickup apparatuses on network dispersedly and information processing method for the same image pickup apparatus.

2. Description of the Related Art

Recently, with prevailing of network system for digital devices, monitor image systems through the network have been developed and manufactured for monitor system using TV camera. In such a monitor image system, plural TV cameras are connected to each other and pieces of image information are stored in its storage section appropriately.

According to a prior art (Jpn. Pat. Appln. KOKAI Publication No. 2001-339710), there is provided a monitor image selection control system which includes plural TV cameras and plural display units and displays a monitor screen selectively.

However, the above-described conventional technology has a problem about the monitor image selecting control system, about how the image information should be dispersed in single image pickup apparatuses each having a recording memory or the like, such as a network camera, which is a problem which the present invention intends to solve. That is, if a recording memory region for storing an alarm image inside the network camera becomes short, a previously stored image is overwritten or cleared to store that new image, and therefore, a network administrator becomes unable to see previous alarm images, which is a problem to be solved by the present invention. In case where a system constituted of plural network camera each having a memory section is constructed on network, how recording memories inside other image pickup apparatuses, which are resources not employed yet on the network, should be employed to solve the shortage of the recording memory region is a problem to be solved.

### BRIEF SUMMARY OF THE INVENTION

According to an aspect of the present invention, there is provided an image pickup apparatus comprising: an image pickup section which photographs an image and outputs its image information, a recording section which stores the image information from the image pickup section, a communicating section which transmits the image information from the image pickup section to an external unit, a determining section which determines which the image information from the image pickup section is stored in the recording section or stored in the external unit through the communicating section as a dispersion processing and a control section which, when the determining section determines that the image information should be stored in the external unit, transmits a request signal for the dispersion processing to the external unit through the communicating section and if an acceptance signal about the dispersion processing is received from the external unit, have the image information transmitted to the external unit.

### BRIEF DESCRIPTION OF THE SEVERAL VIEWS OF THE DRAWING

FIG. 1 is a block diagram showing an embodiment of the structure of the image pickup apparatus according to this embodiment;

FIG. 2 is an explanatory diagram showing an example of a connecting method for connecting the image pickup apparatus of the present invention to a network;

FIG. 3 is a sectional view showing an embodiment of the structure of the image pickup apparatus according to the present invention;

FIG. 4 is a flow chart showing an example of dispersion processing on the transmission side of the image pickup apparatus of the present invention;

FIG. 5 is a flow chart showing an example of dispersion processing on the reception side of the image pickup apparatus of the present invention;

FIG. 6 is a flow chart showing an example of collection processing on the transmission side of the image pickup apparatus of the present invention; and

FIG. 7 is a flow chart showing an example of collection processing on the reception side of the image pickup apparatus of the present invention.

### DETAILED DESCRIPTION OF THE INVENTION

Hereinafter, the network camera, which is an image pickup apparatus of the present invention will be described in detail with reference to the accompanying drawings.

<Network Camera which is an Image Pickup Apparatus of the Present Invention>

(Configuration)

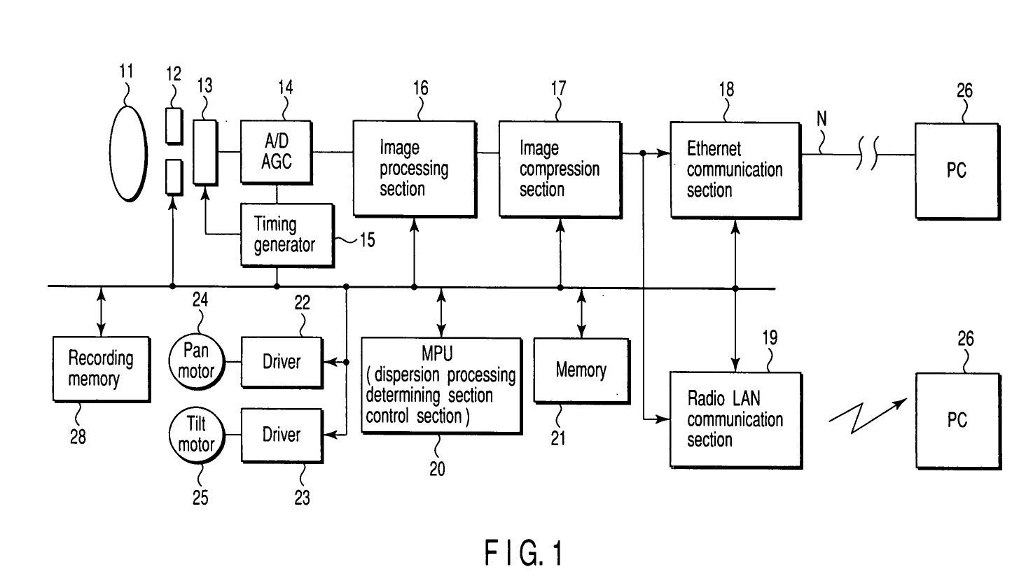

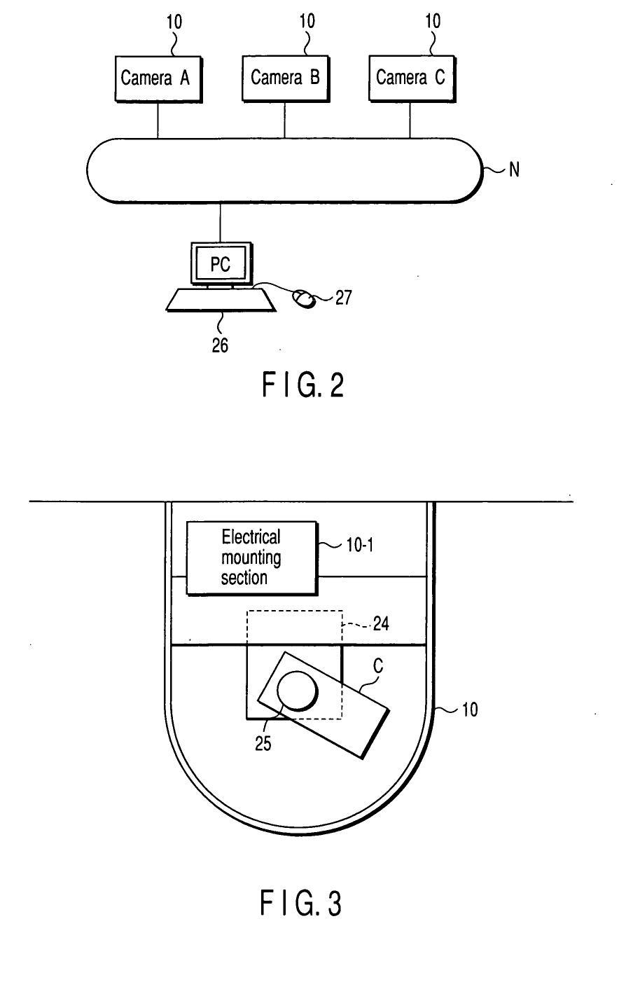

The image pickup apparatus and image pickup system of the present invention will be described by taking a network camera and a personal computer (PC) connected to the same network as an example, with reference to the accompanying drawings. FIG. 1 is a block diagram showing an embodiment of the structure of the image pickup apparatus according to the present invention. FIG. 2 is an explanatory diagram showing an example of a connecting method for connecting the image pickup apparatus of the present invention to the network. FIG. 3 is a sectional view showing an embodiment of the structure of the image pickup apparatus of the present invention.

As shown in FIG. 1, a network camera unit 10 which is an image pickup apparatus of the present invention comprises an objective lens 11, a mechanical iris mechanism 12 which receives incident light passing the objective lens 11, receives a control signal corresponding to a predetermined exposure value and corrects exposure mechanically corresponding to the same control signal and a solid image pickup apparatus 13 such as charge coupled device (CCD) which receives incident light subjected to the exposure correction and outputs a detection signal corresponding thereto. Further, this solid image pickup apparatus 13 receives a control signal for controlling conversion processing timing for converting the detection signal corresponding to incident light from a timing generator 15 so as to carry out the conversion processing. The exposure correction is enabled by corresponding to a timing given by this control signal also. Further, the detection signal from the solid image pickup apparatus 13 is supplied to an A/D converter auto gain controller (AGC) which executes gain control and converted to digital signals and further, converted to an appropriate value corresponding to the control signal from the timing generator 15 and outputted.

The network camera unit 10 further includes an image processing section 16 which receives an output from the A/D converter AGC circuit 14 and an image compression section 17 which carries out compression processing such as MPEG compression, JPEG compression upon the image signal subjected to the image processing. The image processing section 16 executes such image processing on the inputted image signal as sharpness processing, contrast processing, gamma correction, white balance processing, pixel addition processing.

The network camera unit 10 further includes a main processing unit (MPU) 20 which controls entire processing action so as to control the dispersion processing/collection processing which is a feature of the present invention described later, a memory 21 which stores a program for controlling these actions and provides a work area for respective processing actions for the image signal and a recording memory 28 which stores photographed image information and alarm video to be recorded upon detecting a motion.

Further, the network camera unit 10 is connected to the MPU 20 through data bus and has an Ethernet communication section 18 and a radio local area network (LAN) communication section 19, so that it executes communication processing with an external PC 26, other image pickup apparatus 10 or the like through wire network N or wireless network.

The network camera unit 10 further includes a pan driver 22 which is connected to the MPU 20 through data bus and controlled so as to drive the camera unit C in a pan direction, a pan motor 24 such as a stepping motor, a tilt driver 23 for driving the camera unit C in a tilt direction and a tilt motor 25 such as a stepping motor. Here, the camera unit has at least, the aforementioned objective lens C, the mechanical iris mechanism 12 and the solid image pickup apparatus 13.

Plural units of the network camera units 10 can be provided through a network N as shown in FIG. 2. Further, the network camera unit 10 can be driven in the pan direction and tilt direction by means of the PC 26 or the like through the network N and image signals picked by the network camera unit 10 can be monitored, recorded and reproduced. Further, a pointing device 27 such as a mouse is connected to the PC 26.

As shown in FIG. 3, the network camera unit 10 contains the camera unit C, a pan motor 24 for driving the camera unit C in the pan direction, a tilt motor 25 for driving it in the tilt direction and an electrical mounting section 10-1 having the structure shown in FIG. 1.

(Basic Operation)

The network camera unit 10 having such a structure executes the basic operation which will be described below. That is, the network camera unit 10 executes image pickup operation of receiving incident light from a photographing object and supplying an image signal corresponding to the image pickup screen through a network, camera drive operation for driving the camera unit C, for example, in the pan direction and tilt direction, various kinds of modes based on photographed image signal (for example, motion detecting action), various kinds of setting actions for setting the exposure correction method, which will be described later, self-test operation and the like.

That is, the image pickup operation is carried out by receiving an instruction signal from the PC 26 or the like, which is a control unit through the network N (or radio network) according to an operation program stored in the memory 21 under a control of the MPU 20. The solid image pickup apparatus 13 which receives incident light from a photographing object through the objective lens 11 supplies a detection signal corresponding to this to the A/D converter circuit AGC circuit 14.

The exposure correction is executed under, for example, controls of the mechanical iris mechanism 12, the solid image pickup apparatus 13 and the AGC circuit 14. That is, the mechanical iris mechanism 12 receives an exposure control signal from the MPU 20 and controls the quantity of light to be picked up so as to execute a desired exposure correction. In the solid image pickup apparatus 13, its shutter speed is corrected as its electronic shutter function and an exposure control signal is received from the MPU 20 so as to supply a timing signal from the timing generator 15 correspondingly. The solid image pickup apparatus 13 executes conversion processing of converting incident light to a detection signal corresponding to the timing of a timing signal so as to adjust the shutter speed. Consequently, the exposure adjustment is performed.

The AGC circuit 14 is supplied with a control signal from the timing generator 15 which receives an exposure control signal from the MPU 20 and correspondingly, controls the gain of a detection signal supplied from the solid image pickup apparatus 13 so as to correct the exposure. Although three-stage exposure correction has been picked up as an example here, the exposure correction can be performed based on any one of them and further can be performed by pixel addition processing in the image processing section 16 or the like.

After zero coordinate adjustment is performed by the pan motor 24 and tilt motor 25, which are stepping motors in the camera driving operation, the MPU 20 always sees the current direction of the camera unit C. The MPU 20 always controls the coordinates of a screen photographed by a current camera unit C and the camera unit C is driven in the pan direction or tilt direction corresponding to an operation control signal supplied from the MPU 20 to the driver, so that a photographed screen is changed and at the same time, the MPU 20 always recognizes current coordinates of the photographed screen. Thus, user can move the camera unit C in the pan direction or tilt direction while watching a photographed screen corresponding to an image signal supplied from the current image pickup apparatus 10, displayed on the PC 26 connected through network and see the photographed screen depending on a move. The MPU 20 recognizes and controls the coordinates of the current photographed screen and user can obtain coordinate information of the current photographed screen on, for example, PC 26, corresponding to his operation.

Under each operation mode, for example, the motion detecting operation mode, the image pickup apparatus 10 automatically detects the motion of an image in an arbitrary region set by user. If an observation region for detecting the motion in the photographing screen is set corresponding to user's operation in the motion detecting operation mode setting screen and if a change of the photographing screen over a predetermined value is detected in that observation region, the MPU 20 determined that the motion is detected, and for example, stores the image information in this period in the recording memory 28 as an alarm image successively, which is preferable.

(Dispersion Processing of the Image Pickup Apparatus of the Present Invention)

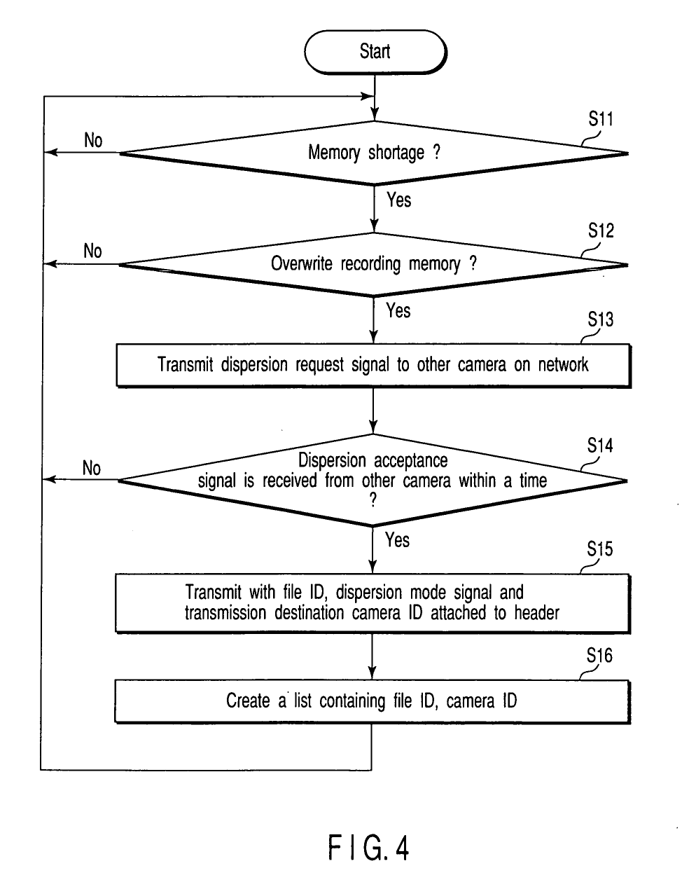

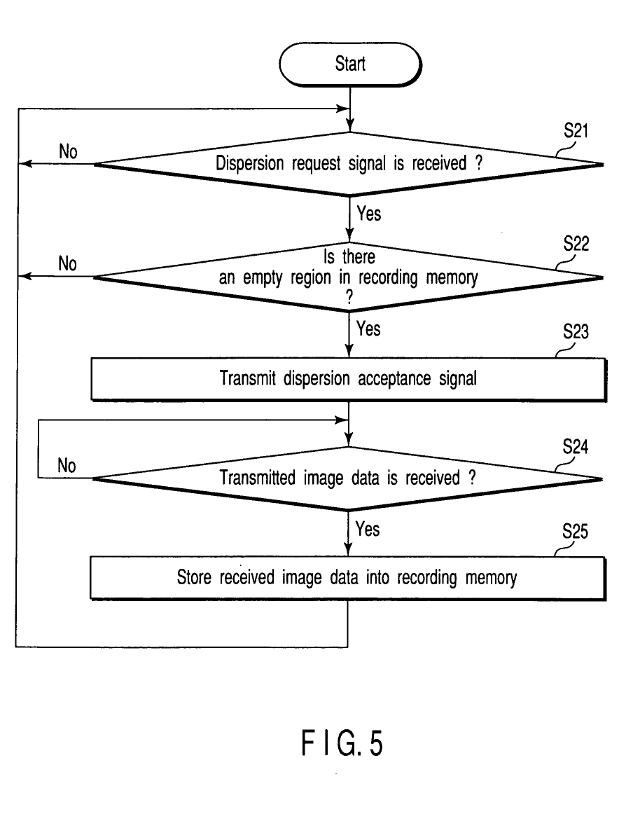

The dispersion processing of image information in the image pickup apparatus of the present invention will be described in detail with reference to a flow chart. FIG. 4 is a flow chart showing an example of the dispersion processing on the transmission side of the image pickup apparatus of the present invention. FIG. 5 is a flow chart showing an example of the dispersion processing on the reception side of the image pickup apparatus of the present invention.

In the image pickup apparatus of the present invention, as indicated in the flow chart of FIG. 4, first, a detection signal from the solid image pickup apparatus 13 through the objective lens 11 and mechanical iris mechanism 12, which are image pickup section, is supplied to the A/D converter AGC circuit 14, which performs gain control, and converted to digital signal. Further, this digital signal is converted to an appropriate value corresponding to a control signal from the timing generator 15 and undergoes image processing in the image processing section 16 and after that, the image is compressed and transmitted to the external PC 26 or the like through the Ethernet communicating section 18 and radio LAN communicating section 19. However, depending the specification, the digital signal from the A/D converter AGC circuit 14 is recorded in the recording memory 28 just as it is, or after it undergoes image processing in the image processing section 16 or after the image is compressed by the image compression section 17.

That is, the picked up image information is not only transmitted directly through the communicating section, but also recorded in the recording memory 28 appropriately depending on the specification. All the image information may be recorded in the recording memory 28 temporarily or only when the motion detection set by the motion detecting operation mode is activated, the image information may be recorded in the recording memory 28 in detail.

If recording processing is carried out in the recording memory 28 corresponding to the specification, memory shortage may occur in the recording memory section 28 (S11). At this time, if the MPU 20 having the function of the dispersion (collection) processing determining section control section detects that a method for recording image information which should be recorded by overwriting on the oldest image information in the recording memory 28 is set up as initial setting by user (S12), it determines that it should overwrite without executing the dispersion processing of the present invention and then controls for overwrite.

However, if the MPU 20 detects a setting for executing the dispersion processing when memory shortage occurs, which is set up as the initial setting (S12), it transmits a dispersion request signal for requesting other image pickup apparatus 10 on the network for the dispersion processing through the communicating sections 18, 19 (S13). When it receives a dispersion acceptance signal saying that the dispersion processing is accepted from a mating image pickup apparatus 10 (S14), the image information is transmitted to the mating image pickup apparatus 10.

At this time, preferably, the MPU 20 generates, for example, file ID (identification information), dispersion mode signal (information an object of the dispersion processing) and transmission destination camera ID (identification information) for the header of the image information and then attaches them to the header before transmission (S15).

The MPU 20 generates list information as the history information which underwent the dispersion processing and stores this in the memory region such as the recording memory section 28 and memory 21 (S16). Consequently, the collection processing which will be described later enables image information dispersed on other image pickup apparatus 10 to be collected easily.

Next, a processing after the dispersion request signal is received by the mating image pickup apparatus 10 for the dispersion processing will be described with reference to a flow chart of FIG. 5. Although the image pickup apparatus 10 on the reception side has the same structure and function as the image pickup apparatus 10 of the transmission side, it does not always need to have the same function but it may contain a higher function as the image pickup apparatus 10.

In the image pickup apparatus 10 on the reception side, if the MPU 20 receives a dispersion request signal from the image pickup apparatus 10 on the transmission side (S21), the image pickup apparatus 10 on the reception side determines whether or not there is an empty region in the recording memory 28 or the like (S22). It is preferable to add a determination about whether or not the dispersion processing is accepted as the initial setting to this determination. The MPU 20 accepts the dispersion processing and if it is determined that there is an empty region in the recording memory 28 or the like, it transmits a dispersion acceptance signal saying that the dispersion processing is accepted through the communicating sections 18, 19.

Correspondingly, image information having the header is transmitted from the image pickup apparatus 10 on the transmission side to the image pickup apparatus 10 on the reception side after a determination indicated in step S14 of the flow chart shown in FIG. 4. If this is received by the image pickup apparatus 10 on the reception side (S24), the received image information is stored in the recording memory 28 and the like (S25).

Consequently, the image pickup apparatus 10 of the present invention is capable of recording image information which should be recorded by making the best use of the recording function of the other image pickup apparatus on the network.

(Collection Processing in the Image Pickup Apparatus of the Present Invention)

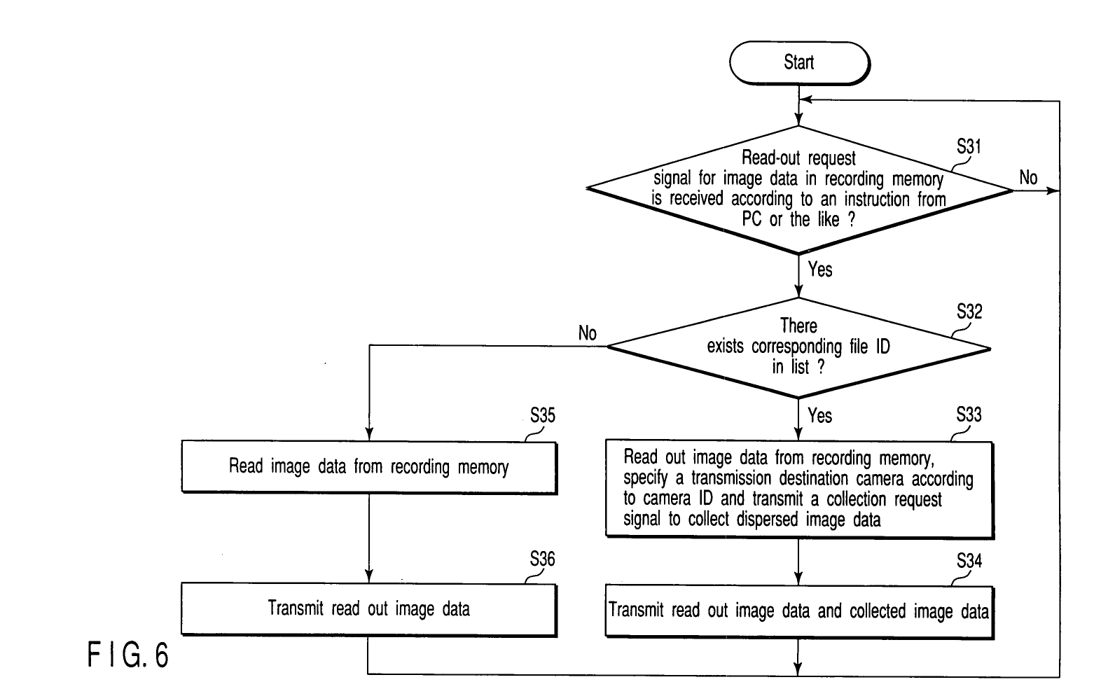

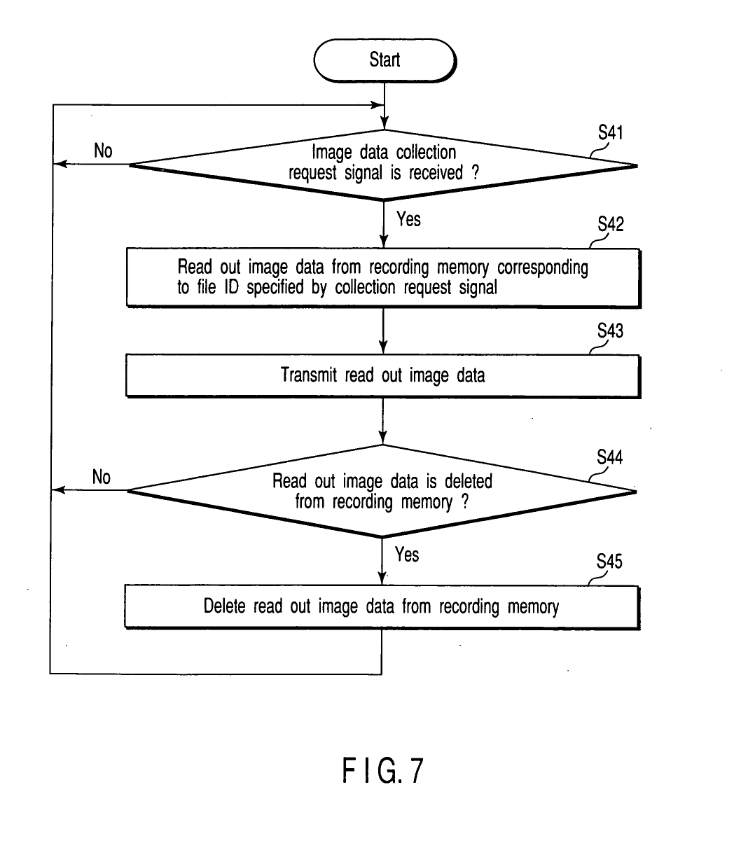

Next, the collection processing which is a post processing of the dispersion processing for the image information in the image pickup apparatus of the present invention will be described in detail with reference to a flow chart. FIG. 6 is a flow chart showing an example of the collection processing on the transmission side of the image pickup apparatus of the present invention. FIG. 7 is a flow chart showing an example of the collection processing on the reception side of the image pickup apparatus of the present invention.

Unless the collection processing for dispersed image information is carried out after the dispersion processing of the image information, the stored image information cannot be used. That is, if a readout request signal or the like for urging the image information recorded as monitor image to be transmitted is transmitted from the PC 26 on the network in FIG. 6, the image pickup apparatus 10 on the transmission side begins the collection processing (S31).

That is, the MPU 20 reads out the aforementioned list information stored in the recording memory 28 or the like so as to determine whether or not there exists image information which is requested to be read out in the PC 26 by using identification information such as the file ID (S32). Unless there exists any image information requested to be read out which undergoes the dispersion processing, the image information requested to be read out is read out from the recording memory 28 of the image pickup apparatus 10 on the transmission side (S35). Then, this read out image information is supplied to the PC 26 on the network N through the communicating sections 18, 19 (S36).

The MPU 20 reads out the aforementioned list information stored in the recording memory 28 or the like and if it is determined that there exists the image information which is requested to be read out by the PC 26 in the list (S32), the MPU 20 creates a collection request signal which requests collection of the image information corresponding to the camera ID (identification information of the image pickup apparatus) corresponding to the file ID of the image information requested to be read out and transmits it to the image pickup apparatus 10 on an appropriate network through the communicating section (S33). Then, the image information transmitted corresponding to this collection request signal is collected and this image information is supplied to the external PC 26 or the like which requests the read-out (S34). Meanwhile if part of the image information which should be supplied exists on the image pickup apparatus 10 on the transmission side and the image pickup apparatus 10 on the external reception side, image information pieces read out from each place are synthesized and then supplied to the external PC 26 or the like.

On the other hand, the collection processing of the image pickup apparatus 10 on the reception side on a dispersion destination will be described in detail. If the MPU 20 which is the image pickup apparatus 10 on the reception side receives a collection request signal which is a collection request signal for the image information (S41), the image information corresponding to the file ID indicated by the collection request signal is read out from the recording memory 28 (S42). Then, the read out image information is transmitted to the image pickup apparatus 10 on the transmission side through the communicating sections 18, 19 (S43). If the read out image information is deleted from the recording memory 28 and if it is set up in the initial setting (S44), the MPU 20 deletes the read out image information from the recording memory 28 (S45). Consequently, the memory capacity of the recording memory in the image pickup apparatus 10 on the reception side is recovered quickly after the dispersion processing and collection processing are carried out.

As described above, in the image pickup apparatus of the present invention, if photographed image information and alarm image provided by alarm detection and the like cannot be stored in the recording memory 28 any more, an empty capacity of the recording memory in the image pickup apparatus 10 or the like on the network is automatically detected and the image information which cannot be automatically recorded is subjected to the dispersion processing. If an image information readout request is dispatched from the PC 26 on the network for control, user can read out necessary image information from the image pickup apparatus 10 only by ordinary read-out operation without being conscious of anything.

In the above description, the dispersion processing and collection processing are carried out by generating and using the list information and header information by an activation of the dispersion processing section control section of the MPU 20. However, if both of them are not always necessary, it is permissible to execute the dispersion processing and the collection processing by only the list information or header information. The above-described dispersion processing and collection processing are just an example, but they can be executed according to other method and the present invention can be extended to a wide range not departing from the disclosed principle and novel feature.

For example, preferably, the image pickup apparatus on the transmission side always registers image pickup apparatuses located on the network and monitors the remaining capacity of the recording memory every predetermined time interval for the dispersion processing and collection processing. Consequently, if the capacity of the recording memory of a self unit becomes short, an image pickup apparatus (image pickup apparatus having the largest empty capacity) most suitable for dispersion is specified immediately, so that the dispersion processing can be carried out.

The PC 26 which has been explained as a control unit on the network may be a digital image recorder having the same function or can execute not only image pickup operation but also recording and reproducing of photographed images.

Those skilled in the art can achieve the present invention through the above-described various embodiments. Further, those skilled in the art can find out various kinds of modifications easily and the present invention can be applied to various embodiments without any special inventive ability. Therefore, the present invention is extended to a wide range not contradicting the disclosed principle and novel feature and is not restricted to the above-described embodiments.

As described above, according to the present invention, there is provided an image pickup apparatus and information processing method for such an image pickup apparatus in which image information which cannot be recorded in a recording memory of its main unit any more is automatically dispersed to other image pickup apparatuses on network without any user's operation, so that the dispersed image information can be collected and read out easily corresponding to user's ordinary read-out operation.

What is claimed is:

1. An image pickup apparatus comprising:
an image pickup section which photographs an image and outputs its image information;
a recording section which stores the image information from the image pickup section;
a communicating section which transmits the image information from the image pickup section to an external unit;
a determining section which determines which the image information from the image pickup section is stored in the recording section or stored in the external unit through the communicating section as a dispersion processing; and
a control section which, when the determining section determines that the image information should be stored in the external unit, transmits a request signal for the dispersion processing to the external unit through the communicating section and if an acceptance signal about the dispersion processing is received from the external unit, have the image information transmitted to the external unit.

2. The image pickup apparatus according to claim 1, wherein the external unit which the control section intends to have the image information stored in is other image pickup apparatus for photographing images.

3. The image pickup apparatus according to claim 1, wherein the control section, when transmitting the image information to the external unit, generates and stores a list indicating that the image information is dispersed.

4. The image pickup apparatus according to claim 1, wherein the control section, when transmitting the image information to the external unit, generates and stores a list information indicating that the image information is dispersed and containing at least one of identification information about the image information and identification information about the external unit which is a dispersion destination of the image information.

5. The image pickup apparatus according to claim 1, wherein the control section, when transmitting the image information to the external unit, attaches at least one of identification information about the image information and identification information about the external unit which is the dispersion destination of the image information to the image information as a header for transmission.

6. The image pickup apparatus according to claim 1, wherein the control section, when receiving a request signal for the dispersion processing from other image pickup apparatus, stores transmitted image information in the recording section.

7. The image pickup apparatus according to claim 1 wherein the control section, when receiving a request signal for the dispersion processing from other image pickup apparatus, determines whether or not the image information can be stored in the recording section and if it is determined that the image information can be stored, transmit an acceptance signal about the dispersion processing to the other image pickup apparatus and further stores the transmitted image information in the recording section.

8. The image pickup apparatus according to claim 1, wherein the control section, when receiving a read-out request signal about the image information from other unit through the communicating section, retrieves list information about the dispersion processing and if image information which should be read out is found, so controls to collect the image information from an external unit of the dispersion destination and transmit to the other unit.

9. The image pickup apparatus according to claim 1, wherein the control section, when receiving a read-out request signal for the image information from other unit, retrieves identification information about the image information corresponding to the request signal from identification information of image information in list information about the dispersion processing executed before and if such identification information is found, so controls to collect the image information according to identification information about the external unit and transmit to the other unit.

10. The image pickup apparatus according to claim 1, wherein the control section, when receiving a request signal for collection of image information stored in the recording section through the dispersion processing from other image pickup apparatus through the communicating section, reads out a corresponding image information from the recording section and transmits to the other image pickup apparatus.

11. An information processing method for an image pick device having a recording section which records photographed image and a communicating section which transmits/receives an image, the method comprising:
photographing an image and outputting image information;
determining which the photographed image information should be stored in the recording section or an external unit through the communicating section as a dispersion processing;
when it is determined that the image information is to be stored in the external unit, transmitting a request signal for the dispersion processing to the external unit through the communicating section; and
when an acceptance signal about the dispersion processing is received from the external unit, so controlling to transmit the image information to the external unit.

12. The information processing method according to claim 11, wherein the external unit in which the image information is to be stored is other image pickup apparatus which photographs an image.

13. The information processing method according to claim 11, wherein, when the image information is transmitted to the external unit, list information indicating that the image information is dispersed is generated and stored under the control.

14. The information processing method according to claim 11, wherein, when the image information is transmitted to the external unit, a list information indicating that the image information is dispersed and containing at least one of identification information about the image information and identification information about the external unit which is a dispersion destination of the image information is generated and stored under the control.

15. The information processing method according to claim 11, wherein, when the image information is transmitted to the external unit, at least one of identification information about the image information and identification information about the external unit which is the dispersion destination of the image information is attached to the image information as a header for transmission.

16. The information processing method according to claim 11, wherein, when a request signal for the dispersion processing is received from other image pickup apparatus, transmitted image information is stored in the recording section under the control.

17. The information processing method according to claim 11 wherein, when a request signal for the dispersion processing is received from other image pickup apparatus, whether or not the image information can be stored in the recording section is determined and if it is determined that the image information can be stored, an acceptance signal about the dispersion processing is transmitted to the other image pickup apparatus and further the transmitted image information is stored in the recording section.

18. The information processing method according to claim 11, wherein, when a read-out request signal about the image information is received from other unit is retrieved, list information about the dispersion processing through the communicating section and if image information which should be read out is found, it is so controlled to collect the image information from an external unit of the dispersion destination and transmit to the other unit.

19. The information processing method according to claim 11, wherein, when a read-out request signal for the image information is received from other unit, identification information about the image information corresponding to the request signal is retrieved from identification information of image information in list information about the dispersion processing executed before and if such identification information is found, it is controlled to collect the image information according to identification information about the external unit and transmit to the other unit.

20. The information processing method according to claim 11, wherein, when a request signal for collection of image information stored in the recording section through the dispersion processing is received from other image pickup apparatus, a corresponding image information is read out from the recording section and transmitted to the other image pickup apparatus.
